(19) United States
(12) Patent Application Publication
(10) Pub. No.: US 2026/0184369 A1
(43) Pub. Date: Jul. 2, 2026

(54) METHODS AND APPARATUS FOR OPERATING A STEER-BY-WIRE STEERING SYSTEM FOR A VEHICLE

(71) Applicant: Ford Global Technologies, LLC, Dearborn, MI (US)

(72) Inventors: Oliver Nehls, Düsseldorf (DE); Sergio Codonesu, Aachen (DE); Hannah Eileen Denomme, South Lyon, MI (US); David Michael Russell, Ann Arbor, MI (US)

(21) Appl. No.: 19/434,986

(22) Filed: Dec. 29, 2025

(30) Foreign Application Priority Data
Dec. 30, 2024 (DE) 102024139910.4

(51) Int. Cl. B62D 6/00

(52) U.S. Cl. CPC B62D 6/003

(57) ABSTRACT

The disclosure relates generally to a steer-by-wire system and, more particularly, to methods and apparatus for operating a steer-by-wire system for a vehicle. An example vehicle comprising a road wheel actuator coupled to at least one road wheel of the vehicle, and a control device configured to determine a target road wheel angle of the at least one road wheel based on a speed of the vehicle, and cause the road wheel actuator to steer the at least one road wheel based on the determined target road wheel angle.

### RELATED APPLICATION

This patent claims priority from DE Patent Application Number 102024139910.4, which was filed on December 30, 2024, and is hereby incorporated by reference in its entirety.

### FIELD OF THE DISCLOSURE

The disclosure relates generally to a steer-by-wire system and, more particularly, to methods and apparatus for operating a steer-by-wire system for a vehicle.

### BACKGROUND

Steer-by-wire steering systems replace mechanical steering connections with electronic sensing, control, and actuation components. Driver steering inputs are processed to determine desired steering behavior, and feedback forces are generated to emulate steering feel without a physical linkage between a steering wheel and road wheels.

### BRIEF DESCRIPTION OF THE DRAWINGS

FIG. 1 depicts a vehicle with a steer-by-wire steering system according to examples disclosed herein,

FIG. 2 is a flowchart representative of example machine readable instructions and/or example operations that may be executed, instantiated, and/or performed by example programmable circuitry to implement the steer-by-wire steering system of FIG. 1

FIG. 3 is a schematic representation of a road wheel angle range in connection with the method of FIG. 2.

FIG. 4 is a block diagram of an example processing platform including programmable circuitry structured to execute, instantiate, and/or perform the example machine readable instructions and/or perform the example operations of FIG. 2 to implement the steer-by-wire system of FIG. 1.

In general, the same reference numbers will be used throughout the drawing(s) and accompanying written description to refer to the same or like parts. The figures are not necessarily to scale.

### SUMMARY

An example vehicle comprising a road wheel actuator coupled to at least one road wheel of the vehicle, and a control device configured to determine a target road wheel angle of the at least one road wheel based on a speed of the vehicle, and cause the road wheel actuator to steer the at least one road wheel based on the determined target road wheel angle.

An example non-transitory computer readable storage medium comprising instructions to cause at least one programmable circuitry to determine a target road wheel angle of at least one road wheel of a vehicle based on a speed of the vehicle, and cause a road wheel actuator of the vehicle to steer the at least one road wheel based on the determined target road wheel angle.

An example method comprising determining a target road wheel angle of at least one road wheel of a vehicle based on a speed of the vehicle, and causing a road wheel actuator of the vehicle to steer the at least one road wheel based on the determined target road wheel angle.

### DETAILED DESCRIPTION

Steer-by-wire steering systems, hereinafter referred to as SBW steering systems, do not require mechanical coupling between the steering wheel and the steerable road wheels. Two actuator subsystems work together to steer the vehicle. A hand wheel actuator with feedback generates feedback torque for the driver on the steering wheel, the hand wheel actuator is also known as a feedback actuator (FBA).Further, a road wheel actuator regulates at least one, but typically several, steerable road wheels to a desired position.

In the case of SBW steering systems with yoke steering wheels or steering wheels that essentially have only one horizontal spoke (e.g., also called horn steering wheels or yoke steering wheels), hereinafter commonly referred to as yoke steering wheels, it is desirable to be able to maintain the same hand position on the steering wheel over the entire steering wheel angle range (e.g., over all possible steering wheel angles) to increase comfort. Therefore, it is known to reduce the steering wheel rotational range for yoke steering wheels as compared to traditional steering wheels. As a result, the entire steering wheel range is achieved within the available steering input range of the yoke steering wheel. This ensures that it is not necessary to change grip on the yoke steering wheel to cover the entire angular range of the steerable road wheels.

By mechanically decoupling the steering wheel from the steerable road wheels, the SBW steering system can include a variable steering ratio, which describes the dependence between these parameters. Because the steering wheel rotational range is reduced in this configuration of yoke steering wheels compared to the steering wheel of conventional steering wheels, the variable steering ratio can lead to unwanted steering behavior, for example if high steering speeds are input by the driver.

Examples described herein provide for a method for operating a steer-by-wire steering system for a vehicle. An example SBW steering system includes at least one steering wheel, a road wheel actuator (e.g., SHEV), and a control device. The road wheel actuator is coupled with at least one steerable road wheel. The method includes at least the following operations. First, a detected steering wheel angle of the steering wheel is received by the control device. A target road wheel angle of the steerable road wheel is determined by the control device based on the received steering wheel angle. The target road wheel angle is limited by road wheel angle limits, which depend at least on the vehicle speed. A control signal is output by the control device to an electric motor of the road wheel actuator or an inverter coupled to the electric motor based on the determined target road wheel angle.

The method is based on the finding that the change in lateral speed of a vehicle in a curve depends on the speed of the vehicle. As vehicle speed increases, a smaller road wheel angle is required to achieve the maximum lateral speed change. Even further steering beyond this point does not increase the change in lateral speed.

According to the examples described herein, the mechanical decoupling of the steering wheel from the road wheels is used to adjust the target road wheel angle, which depends on the steering input in the form of the steering wheel angle of the steering wheel. For this purpose, road wheel angle limit values are considered, which are based on the vehicle speed. The road wheel angle limits are therefore variable depending on the vehicle speed. As a result, the target road wheel angle is limited in such a way that the maximum lateral speed change can always be achieved, but the steerable road wheel is essentially only moved (e.g., turned) up to the corresponding target road wheel angle. This allows for a configurable design of the target road wheel angle over different vehicle speeds and an optimal response to the respective steering wheel angle. As a result, an optimized target road wheel angle determination is enabled, which is not limited by the having to be able to reach the mechanical end stops of the steerable road wheel. For example, an adapted dependence of the required target road wheel angle on the steering wheel angle of the steering wheel can be considered, which optimizes the steering behavior of the SBW steering system, especially for steering wheels with small steering ranges.

The road wheel angle limit values represent vehicle speed-dependent limit values of the target road wheel angle. The road wheel angle limits are different from maximum mechanical road wheel angle stops, which mechanically limit the road wheel angle. The road wheel angle limit values also do not represent the end positions of the target road wheel angle specified by control technology, which are intended to prevent contact with the mechanical road wheel angle end stops. Such predetermined end positions are used to protect the mechanical road wheel angle end stops, but not to limit the target road wheel angle with respect to the maximum lateral speed change of the vehicle. Rather, the road wheel angle limit values represent situationally variable, determined and considered limitations of the road wheel angle. In extreme cases, the road wheel angle limits may coincide with the control end positions of the road wheel angle, which are provided to prevent contact with the mechanical road wheel angle end stops. However, due to the dependence on vehicle speed, the road wheel angle limit values differ from corresponding end positions intended to protect the mechanical road wheel angle end stops.

In some examples, the control device receives a vehicle speed from the vehicle and considers the received vehicle speed when determining the target road wheel angle. The road wheel angle limits already depend on the vehicle speed. This means that vehicle speed-dependent limit values are already considered for the target road wheel angle, depending on the situation. In addition, however, the target road wheel angle can also depend on the vehicle speed within the interval of possible target road wheel angles spanned by the road wheel angle limits. For example, the target road wheel angle may be linearly dependent on vehicle speed for low vehicle speeds and may show an increasingly progressive relationship for higher vehicle speeds. This enables the SBW steering system to steer smoothly from the central area of the steering wheel angle (e.g., the area of small steering wheel angles relative to the reference position of the center position (straight alignment)) to the off-center area. Based on the method, it is no longer necessary to achieve the mechanical road wheel angle end stops of the road wheel angle for every vehicle speed. This means that the entire mechanical road wheel angle range no longer has to be considered. Therefore, there is no longer a need to make the steering behavior of the SBW steering system progressive to ensure sufficient steerability within a relatively small steering range. This is made possible by the fact that a relatively smaller road wheel angle is required as the vehicle speed increases, which is considered by the dependence of the target road wheel angle on the vehicle speed.

According to one aspect, when determining the target road wheel angle, the control device can consider a variable steering ratio between the detected steering wheel angle of the steering wheel and the target road wheel angle. The variable steering ratio depends on the vehicle speed. This allows the steering behavior of the SBW steering system to be adapted as required. This means that different steering inputs in the form of different steering wheel angles on the steering wheel cause different effects on the lateral guidance of the vehicle based on the steering of the steerable road wheel, provided that the vehicle speed varies.

The variable steering ratio, in some examples, is less direct at higher vehicle speeds. In general, at higher vehicle speeds, the vehicle user reacts with smaller steering inputs based on appropriate steering wheel angles. This can be considered by the variable steering ratio. Nevertheless, the dependence of the target road wheel angle on the vehicle speed means that even steering inputs with high steering wheel speeds or relatively large steering wheel angles lead to corresponding changes in the angle of the road wheel, which ensure the maximum lateral speed change of the vehicle.

In some examples, instead of the target road wheel angle, the control device can also determine a target rack travel of a rack or a target pinion angle of a pinion based on the received steering wheel angle. Both the target rack travel and the target pinion angle correspond to the target road wheel angle. The rack and pinion are at least indirectly coupled to the steerable road wheels and the road wheel actuator, or to several road wheels, at least if a single road wheel actuator is intended to be coupled with several steerable road wheels via a common rack. The target rack travel is limited by rack and pinion travel limits. The target pinion angle is limited by pinion angle limits. The rack and pinion travel limits and the pinion angle limits correspond to the road wheel angle limits and therefore depend on the vehicle speed. The actuator emitted by the control device can then alternatively depend on the determined target rack and pinion path or the determined target pinion angle. Because the rack and pinion are at least indirectly coupled to the road wheel actuator and the steerable road wheel, the corresponding variables can be used for control as an alternative to the road wheel angle. All explanations regarding the target road wheel angle and the road wheel angle limit values are therefore transferable in a corresponding manner to the target rack and pinion travel, the target pinion angle, the rack travel limit values and the pinion angle limit values.

In some examples, the road wheel angle limit values can depend on the vehicle speed in such a way that a vehicle transverse speed change corresponding to a specified speed change limit value is achievable for each vehicle speed. The velocity change limit can be 1.5 G, in some examples 1.3 G, further in some examples 1.2 G, further in some examples 1 G. G stands here for the average acceleration due to the Earth's gravity, which is of 9.81 m/s². These limits represent typical maximum lateral speed changes of vehicles. In this respect, the SBW steering system ensures that the steerability of the vehicle in terms of lateral guidance is maximum at all vehicle speeds, and that this maneuverability is also achieved for steering wheels with small steering ranges via comfortable steering behavior.

In some examples, a tolerance road wheel angle range is considered for each vehicle speed for counter steering and/or corrective steering inputs using the steering wheel, for example when the vehicle is in an oversteering or understeering configuration. In some examples, the tolerance road wheel angle range depends on the vehicle speed. In some examples, the tolerance road wheel angle range can be configured at the road wheel angle limit value as a support point. In this respect, the tolerance road wheel angle range denotes an additional parameter range of the road wheel angle that can be reached for the target road wheel angle. This means that the road wheel angle limit value represents a support point around which corresponding tolerance road wheel angle ranges are considered to be able to depict situational counter steering. This ensures that the driver of the vehicle can use a sufficient counter steering or auxiliary steering angle in understeering or oversteering situations.

In vehicles equipped with an electronic stability control (ESC) function, the required counter steering is significantly reduced or even eliminated, depending on the tuning, setting and effectiveness of the steering system. To further support the driver in oversteering situations, a handling controller can also be used, which adds or subtracts a delta road wheel angle to the result of the variable steering ratio to help the driver counter steer. Generally, the driver reacts too slowly and/or too little in oversteering situations. The handling controller reacts more quickly and can thus further reduce the driver's counter-steering deflection. An additional rack and pinion travel is required for the handling controller, which is accounted for by the tolerance road wheel angle range.

When understeering, most drivers generally continue to turn, although the additional steering angle does not cause a stronger vehicle response, as the lateral force of the road wheel is already saturated and therefore further turning does not cause a greater change in lateral speed. In other words, a tighter curve of the vehicle is not possible. Modern ESC functions typically detect understeering and support vehicle steering through a speed reduction process that reduces vehicle speed and generates additional torque around the vehicle's vertical axis, thereby achieving a tighter curve radius. Typically, the systems use the driver's extra steering angle as a measure of the strength of the process. Therefore, an additional road wheel angle range is required, which is appropriately considered by the tolerance road wheel angle range.

According to one design, the target road wheel angle can therefore be defined by the road wheel angle required to achieve the maximum change in transverse speed, for example a change in transverse speed of 1 G, depending on the vehicle's speed, a tolerance road wheel angle range during understeer situations, equivalent to a delta angle of the road wheel, a tolerance road wheel angle range for counter steering in oversteering situations, equivalent to a delta angle of the road wheel, a tolerance road wheel angle range for advanced steering functions, such as a handling controller, or combinations of these.

It should be considered that only one tolerance road wheel angle range (e.g., delta angle of the road wheel) of the tolerance road wheel angle ranges for understeering situations and oversteering situations must be considered. In particular, the larger tolerance road wheel angle range is simply considered.

In some examples, the tolerance road wheel angle range is ±20 mm or less of the road wheel angle in each direction, in some examples ±10 mm or less, further in some examples ±5 mm or less, further in some examples ±3 mm or less. In some examples, the tolerance road wheel angle range can also be a percentage range measured against the road wheel angle limit, for example ±20%, in some examples ±10%, further in some examples ±5%, further in some examples ±3%.

In some examples, the control device can consider other steering functions, such as a so-called μ-split control. The μ-split control refers to a control function in which a slip limitation control is exercised to limit slip of a road wheel. Slip limitation control is carried out during the vehicle's journey on a road surface with different coefficients of friction of the road wheels on the right and left sides. In such examples, the control device performs a steering angle control to adjust a road wheel angle of the front road wheels on the left side and on the right side and/or a road wheel angle of the rear road wheels on the left side and on the right side. The steering angle control limits any influence on the vehicle caused by the yaw moment. The yaw moment is caused by a longitudinal force difference between the road wheels on the right side and on the left side on a corresponding roadway. The control device then adjusts the steering angle of the road wheels depending on the side of the vehicle to limit the yaw moment caused by the road surface. For this purpose, the control device can also provide a tolerance road wheel angle range. Compared with the tolerance road wheel angle ranges for understeer situations and over-steering situations, only the single tolerance road wheel angle range for the μ-split control has to be considered by the control device, which simplifies the control.

Consideration of a tolerance road wheel angle range may result in the control device determining an adjusted target road wheel angle that exceeds an original road wheel angle limit (e.g., excluding a tolerance road wheel angle range) but is within the tolerance road wheel angle range supported by the control device, starting from the road wheel angle limit. The achievable parameter space of the target road wheel angle is extended by the tolerance road wheel angle range (e.g., compared to the road wheel angle limit). If an adjusted target road wheel angle is determined by the control device, the control signal output to the electric motor is also adjusted accordingly.

In some examples, when tuning the ESC function, it can be considered that the counter-steering angle is artificially limited based on the road wheel angle limit and the tolerance road wheel angle range. In some examples, the driver's inputs are used to evaluate the vehicle status and the route desired by the driver. Because the method artificially limits the rider's inputs, an adapted ESC function can consider an adapted response to the rider's smaller and/or slower inputs to the same system output (e.g., the same change in the road wheel angle of the steerable road wheels). This allows the adapted ESC function to be adapted to the method, so that the well-known support of the driver by the ESC function is generally ensured.

In some examples, a steering wheel of the steering wheel is a predetermined steering wheel angle starting from a center position. For example, the specified steering wheel angle can be ±220° starting from the center position, in some examples ±200°, further in some examples ±180°, further in some examples ±150° or less. While typical steering wheels can be rotated in any direction for more than one full turn starting from the center position (e.g., the straight position), steering wheels are also known to have small steering ranges. As a result, the method is configured for steering wheels that have relatively small steering ranges. The steering range refers to the maximum possible steering angle between mechanical end stops of the steering wheel or between steering wheel limit values specified by control technology, which are intended to protect the mechanical end stops of the steering wheel or to limit the steering wheel in principle. For example, the steering wheel limit values can be specified by the hand wheel actuator setting a high counter-torque when a 180° steering angle occurs. In general, the driver can then steer even further with high force but will usually not do so due to the high counter-torque.

In some examples, the steering wheel is a yoke steering wheel with a small steering range. The procedure ensures that a driver of the vehicle does not have to reach around when holding the steering wheel with his hands, even at large steering wheel angles. This increases driver comfort while ensuring optimized steering behavior of the SBW steering system.

In some examples, the road wheel actuator outputs torque based on the actuator received by the control device via the electric motor, so that the steerable road wheel is rotated according to the target road wheel angle. Because the target road wheel angle is limited with an optional tolerance road wheel angle range based on the road wheel angle limits, the electric motor of the road wheel actuator will not move the steerable road wheel to a position beyond the road wheel angle limits with the optional tolerance road wheel angle range. In terms of the steerability of the vehicle, this would have no effect anyway, as the road wheel angle limits reflect the configuration of the maximum lateral speed change of the vehicle as a function of the vehicle's speed.

According to a further aspect, the example also relates to a computer program product, comprising instructions which, when executed by a processor, cause the computer program product to perform at least partially the method described above, for example, the computational and output operations. The benefits achieved by the process described herein are also achieved in a corresponding manner by the computer program product.

According to an additional aspect, the example also relates to a non-transitory computer-readable storage medium, comprising commands which, when executed by a processor, cause the computer program product to at least partially execute the method described above, for example, the measurement, simulation, and calculation operations. The advantages achieved by the process described herein are also achieved in a corresponding way by the non-transitory computer-readable storage medium.

According to one aspect, some examples of the disclosure concern an SBW steering system for a vehicle. The SBW steering system includes at least one steering wheel, one road wheel actuator, and one control device. The road wheel actuator is coupled with at least one steerable road wheel. The control device is configured to receive a detected steering wheel angle of the steering wheel, determine a target road wheel angle of the steerable road wheel based on the received steering wheel angle, the target road wheel angle is limited by road wheel angle limits which depend at least on the vehicle speed, and output a control signal to an electric motor of the road wheel actuator or an inverter coupled to the electric motor based on the determined target road wheel angle.

The advantages achieved by the method are also achieved in a corresponding way by the SBW steering system. In particular, the steering of the road wheel can also be optimized for small steering ranges, generally ensuring comfortable steering behavior for the driver. This is made possible by limiting the road wheel angle as a function of the vehicle's speed, which ensures the maximum change in lateral speed that can be achieved in each situation.

In one design, the SBW steering system includes at least one steering wheel sensor that is configured to detect a steering wheel angle of the steering wheel. This allows the target road wheel angle to be precisely adjusted to the driver's steering input.

In some examples, the SBW steering system includes at least one sensor that is configured to detect a measured variable influenced by the road wheel actuator and transmit it to a hand wheel actuator (e.g., an FBA) and/or to the road wheel actuator and/or the control device. The hand wheel actuator is configured to apply feedback torque to the steering wheel that depends on the measured variable. For example, a feedback torque can also be provided for the driver at the steering wheel to provide him with a situation-adapted feeling about the vehicle's lateral guidance depending on the output of the road wheel actuator.

The control device can adjust the steerable road wheel based on the measured variable according to the target road wheel angle. The control device can be part of the road wheel actuator. The control device can also be part of the hand wheel actuator. The control device can also be separated from the road wheel actuator and the hand wheel actuator. The control device can also be a part of another component of the vehicle, such as a driving control device that performs other control functions.

According to one aspect, some examples of the disclosure concern a vehicle with a SBW steering system as described above. The advantages achieved by the SBW steering system are also achieved in a corresponding way by the vehicle. The vehicle can be a land vehicle. The vehicle can have an internal combustion engine, can be an electric vehicle, or can be a hybrid vehicle.

All of the features mentioned below with respect to the examples and/or accompanying figures may be combined, alone or in any sub-combination, with features of the examples disclosed herein.

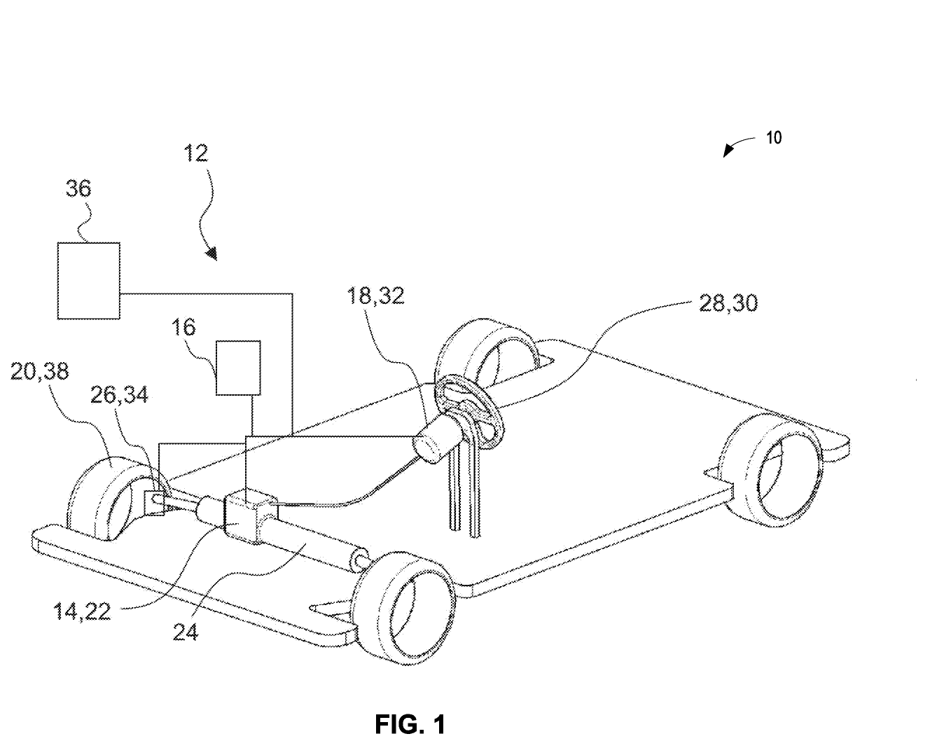

FIG. 1 shows a vehicle 10 with a SBW steering system 12 according to the example. The SBW steering system 12 includes a road wheel actuator 14 and a control device 16. The SBW steering system 12 also includes a hand wheel actuator 18. The hand wheel actuator 18 and the road wheel actuator 14 are linked to each other. The control device 16 is shown separately from the road wheel actuator 14. In general, however, the control device 16 can also be part of the road wheel actuator 14 or the hand wheel actuator 18 or be distributed between both the road wheel actuator 14 and the hand wheel actuator 18.

The road wheel actuator 14 is indirectly coupled with steerable road wheels 20 of vehicle 10. For this purpose, the road wheel actuator 14 includes an electric motor 22 coupled to a rack 24 according to the illustrated example. The rack 24 is coupled with the steerable road wheels 20 of the vehicle 10. The displacement of the rack 24 with respect to a reference position, such as a zero position (e.g., a straight line), results in a change in the orientation of the steerable road wheels 20 around the steering axles of the respective road wheels 20.

In some examples, the road wheel actuator 14 can also be indirectly equipped to rotate a single road wheel 20. If vehicle 10 has several steerable road wheels 20, the SBW steering system 12 in such examples has several road wheel actuators 14 and/or several electric motors 22, each of which is assigned to individual steerable road wheels 20 and which can individually influence the road wheel angle of the individual steerable road wheels 20.

The SBW steering system 12 includes a sensor 26 that is configured to detect an operating parameter of the SBW steering system 12 affected by the operation of the road wheel actuator 14, such as a road wheel angle of the steerable road wheels 20, a rack and pinion travel of the rack 24, or a pinion angle of a pinion coupled to the road wheel actuator 14 and the rack 24. In some examples, the sensor 26 can also be configured as a torque sensor, which is configured to detect the torque output by an electric motor 22 of the road wheel actuator 14 to a component coupled to it, such as the rack 24. In addition, the measured values of the operating parameters recorded in this way are transmitted from the sensor 26 to the road wheel actuator 14 and/or the hand wheel actuator 18. In some examples, several sensor units can also form sensor 26 together, which enables mutual plausibility checks and redundancy.

The SBW steering system 12 also includes a steering wheel 28, to which the hand wheel actuator 18 is at least indirectly coupled, for example via a steering column. The hand wheel actuator 18 is configured to apply feedback torque to the steering wheel 28, which gives the driver of the vehicle 10 a sense of lateral control of the vehicle 10. The driver of the vehicle 10 can use the steering wheel 28 to perform steering instructions (e.g., inputs) for the vehicle 10.

In the illustrated example, the steering wheel 28 is a yoke steering wheel. The steering wheel range 30 of the steering wheel 28 is therefore smaller (e.g., shorter) compared to that of a conventional steering wheel. In particular, in accordance with this example, the steering wheel 28 has a steering wheel range 30, according to which the steering wheel 28 can be rotated by a maximum of ± 180° starting from the central position (e.g., straight alignment) on the basis of control inputs. In some examples, other steering cycle paths specified by the control system can be implemented. According to the illustrated example, the steering wheel 28 can therefore only be rotated by half a turn from the center position. This means that the driver of vehicle 10 does not need to change a hand position when steering with the steering wheel 28 (e.g., the driver does not have to change grip).

The steering wheel 30 is limited by mechanical steering wheel end stops. In addition, the hand wheel actuator 18 considers regulatory limit values for the steering wheel range 30 so that the driver of vehicle 10 does not move the steering wheel 28 in such a way that the mechanical steering wheel end stops are loaded (e.g., contacted).

In some examples, the steering wheel end stops can also enable a larger mechanical steering wheel, but this is limited in terms of control technology, for example because the hand wheel actuator 18 outputs high feedback torque for steering wheel angles greater than ± 180° starting from the center position.

The SBW steering system 12 also includes at least one steering wheel sensor 32 that is configured to detect a steering wheel angle (e.g., a steering wheel position of the steering wheel 28 in relation to a reference position, such as a center position). Consequently, the steering wheel sensor 32 can be used to detect steering inputs from the driver of the vehicle 10 based on the steering wheel 28. In this respect, a steering input defines a specific current steering wheel angle and steering wheel speed. A current steering input corresponds to a specific current target road wheel angle according to which the steerable road wheels 20 should be aligned. Because the road wheels 20 are at least indirectly coupled to the steerable road wheels 20 with the rack 24 and a pinion in the power transmission path of the road wheel actuator 14, the steering input is equivalent to a target rack travel of the rack 24 and a target pinion angle of the sprocket so that a desired orientation of the road wheels 20 is achieved.

Changing the steering wheel position dynamically changes the current steering preset by the driver, which in turn results in a dynamic change in the target road wheel angle. The dependence of the target road wheel angle on the current steering input in the form of the current steering wheel angle is considered by the control device 16 in the context of a steering ratio. The steering ratio thus describes how the target road wheel angle varies dynamically depending on the steering wheel angle. In general, the steering ratio is variable (e.g., a variable steering ratio). This means that the target road wheel angle, especially for small steering wheel angles, can depend linearly on the steering wheel angle in relation to the reference position (e.g., center position). For larger steering wheel angles, a transition to a non-linear dependency ratio is considered.

In some examples, the steering wheel sensor 32 is integrated into the hand wheel actuator 18. However, in other examples, the steering wheel sensor 32 may be separate from the hand wheel actuator 18. The steering wheel sensor 32 is configured to transmit the detected steering wheel angle to the road wheel actuator 14 and/or to the hand wheel actuator 18.

The control device 16 includes a processor. The control device 16 is configured to receive the steering wheel angle from the steering wheel sensor 32. Based on the steering angle requirements received, the control device 16 can determine the corresponding current target road wheel angle and other variables or characteristics of the SBW steering system 12. The control device 16 is also configured in such a way that it outputs corresponding control signals to the electric motor 22 of the road wheel actuator 14 or an inverter coupled to the road wheel actuator 14. To execute the corresponding control routines, the control device 16 can consider other parameters of the vehicle 10, such as the vehicle speed.

To detect vehicle speed, the vehicle 10 is equipped with a speed sensor 34, which is equipped to detect vehicle speed and transmit it to the road wheel actuator 14 and/or the hand wheel actuator 18. In some examples, the control device 16, the road wheel actuator 14, and/or the hand wheel actuator 18 may also receive the vehicle speed from another vehicle component, such as a driving control device or a control device that performs other control functions. Based on the control signal, an output torque is provided by the electric motor 22 of the road wheel actuator 14 to align the steerable road wheels 20 accordingly. The output torque is exerted from the electric motor 22 of the road wheel actuator 14 to the rack 24, so that an orientation of the steerable road wheels 20 is indirectly varied.

The sensor 26 detects a property influenced by the road wheel actuator 14, such as the road wheel angle of the steerable road wheels 20, a displacement of the rack 24 or a pinion angle of a pinion and transmits the measured variable to the road wheel actuator 14 and the hand wheel actuator 18. The hand wheel actuator 18 determines a corresponding feedback torque, which is output to the steering wheel 28. The SBW steering system 12 can also include several similar and generally identical components, such as several of the steering wheel sensors 32, which ensures redundancy.

According to the illustrated example, the vehicle 10 includes a vehicle control device 36. The vehicle control device 36 is configured to perform autonomous or semi-autonomous driving functionalities. For example, the vehicle control device 36 can autonomously influence the lateral control of vehicle 10. For this purpose, the vehicle control device 36 can, for example, set a input for the steering wheel angle, which is subsequently adjusted accordingly by the hand wheel actuator 18 of the SBW steering system 12. The steering wheel angle is detected by the steering wheel sensor 32 and transmitted to the road wheel actuator 14 or it is transmitted directly to the road wheel actuator 14 by the vehicle control device 36.

In the illustrated example, the SBW steering system 12 is shown as front-axle steering. The vehicle 10 and the SBW steering system 12 can also, in some examples, include other steerable road wheels 20, such as rear wheels coupled with an additional common road wheel actuator 14.

The steerable road wheels 20 can be moved by the road wheel actuator 14 between mechanical road wheel angle end stops 38. To prevent stress on the mechanical road wheel angle end stops 38, the road wheel actuator 14 considers the end positions of the road wheel angle specified by the control technology.

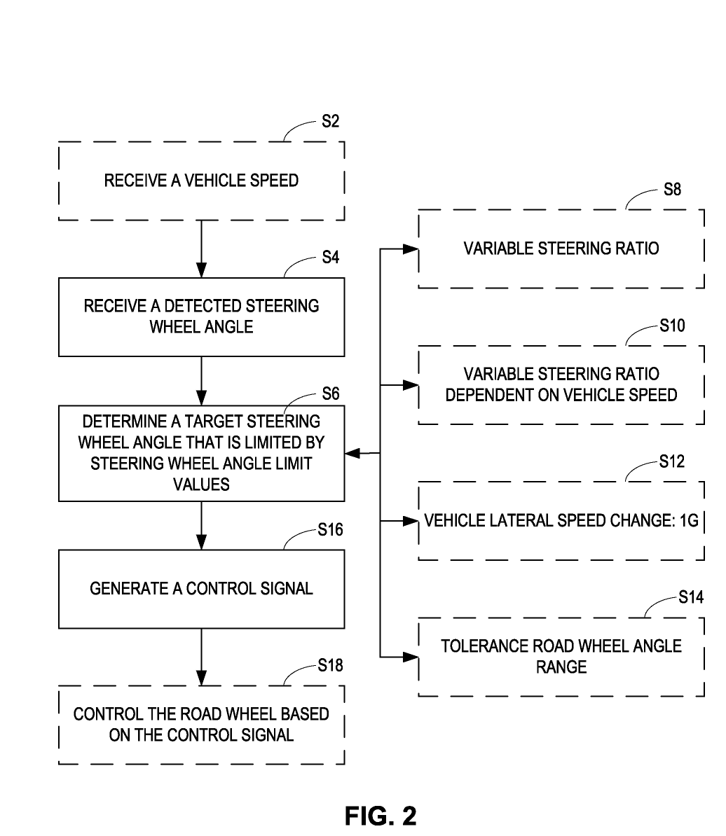

FIG. 2 is a flowchart representative of example machine readable instructions and/or example operations that may be executed, instantiated, and/or performed by example programmable circuitry to implement the steer-by-wire steering system 12 of FIG. 1. In the optional operation S2, the control device 16 receives a vehicle speed of the vehicle 10. For example, the vehicle speed of the vehicle 10 can be detected by the speed sensor 34 and transmitted to the control device 16.

In the subsequent operation S4, the control device 16 receives a detected steering wheel angle of the steering wheel 28. The steering wheel angle of the steering wheel 28 is detected by the steering wheel sensor 32 and transmitted to the control device 16. In such an example, the steering wheel 28 is a yoke steering wheel whose steering range is limited to one full rotation. Starting from a middle position (e.g., a straight position), the yoke steering wheel can be rotated by ±180°.

In the next operation S6 of the method, the control device 16 determines a target road wheel angle of the steerable road wheels 20 based on the received steering wheel angle. The target road wheel angle is limited based on road wheel angle limits, which depend at least on the vehicle speed of vehicle 10. This means that the control device 16 applies a gear ratio between the steering wheel angle and the target road wheel angle to determine the target road wheel angle of the steerable road wheels 20. Operation S6 can be further implemented in by the optional operations S8 to S14.

In some examples, operation S8 can be implemented, in which the control device 16 considers a variable steering ratio between the detected steering wheel angle and the target road wheel angle. For example, for small steering wheel angles, starting from the reference position of the center position of the steering wheel 28, a linear dependence of the target road wheel angle on the detected steering wheel angle can be considered. For relatively larger steering wheel angles, starting from the reference position, the target road wheel angle can then depend non-linearly on the detected steering wheel angle. For example, direct steering behavior and/or progressive steering behavior can be considered for different areas of the measured steering wheel angle.

According to the optional operation S10, the control device 16 considers a variable steering ratio, which depends on the vehicle's speed. Although the road wheel angle limits are already dependent on the vehicle speed of the vehicle 10, the speed-dependent variable steering ratio allows dynamic dependencies between the target road wheel angle and the detected steering wheel angle to be considered. This means, for example, that for the same relative angular offset of the detected steering wheel angle from the reference position (e.g., a straight alignment), different steering behaviors for different vehicle speeds are considered. If the vehicle has 10 high vehicle speeds, the driver typically acts with only minor steering inputs based on small steering wheel angles, measured by the straight-line position reference position (e.g., a straight alignment). At low vehicle speeds, for example during parking maneuvers, a different steering behavior can be generally ensured. This provides a variable steering ratio that considers the vehicle speed of the vehicle 10 depending on the driving situation.

In some examples, the optional operation S10 can be used by the control device 16 to consider a variable steering ratio, which is less direct at higher vehicle speeds (e.g., in comparison with lower vehicle speeds) and results in smaller target road wheel angles for the same captured steering wheel angles.

According to the optional operation S12, the road wheel angle limits are determined by the control device 16 in such a way that a vehicle transverse speed change of 1G is achievable. In this way, the control device 16 generally ensures that the steerability of the vehicle 10 in terms of lateral guidance is maximum at all vehicle speeds. The road wheel angle limits correspond to a specific steering wheel angle of the steering wheel 28 based on the steering ratio. Without the corresponding limitation by the road wheel angle limits, the driver of vehicle 10 could further twist the steering wheel 28 to larger road wheel angles. This would correspond to larger target road wheel angles. However, as vehicle speed increases, a smaller road wheel angle is required to achieve the maximum lateral speed change of the vehicle 10. Even further rotation of the steering wheel 28 beyond the corresponding steering wheel angle does not further increase the lateral speed change of the vehicle 10. It follows that the target road wheel angle can be limited by appropriate road wheel angle limits, which depend on the vehicle speed and which are configured in such a way as to generally ensure the maximum vehicle transverse speed change.

In some examples, operation S14 can also be considered, in that the control device 16 considers a tolerance road wheel angle range with respect to the road wheel angle limits. Based on the tolerance road wheel angle range, a tolerance range can be created for specific driving situations, such as oversteering situations, understeering situations, and/or a μ-split steering function of the control device 16. To consider the tolerance road wheel angle range, the control device 16 may have a handling controller that performs the appropriate steering functions. Because the tolerance road wheel angle range is spanned from the road wheel angle limit, the target road wheel angle can then also take values beyond the road wheel angle limit.

As a result of the optional operations S8 to S14, the target road wheel angle depends on the road wheel angle of the steerable road wheels 20, which is required to achieve the maximum transverse speed change of 1G depending on the vehicle speed of the vehicle 10, a tolerance road wheel angle range for understeer situations, equivalent to a 20 road wheel delta angle, a tolerance road wheel angle range for counter steering in oversteering situations, equivalent to a delta angle of road wheels 20, a tolerance road wheel angle range for advanced steering functions, such as μ-split control, which provides slip limitation control for different road wheels 20 to compensate for different coefficients of friction, for example via a handling controller, and/or combinations of these.

Following operation S6, the method includes operation S16, in which the control device 16 determines a control signal for the electric motor 22 of the road wheel actuator 14 based on the determined (e.g., or adjusted on the basis of the tolerance road wheel angle range) target road wheel angle and outputs it to the electric motor 22 of the road wheel actuator 14. The road wheel actuator 14 indicates the target road wheel angle of the steerable road wheels 20 to be generated.

In the optional subsequent operation S18, the road wheels 20 (e.g., generally at least one road wheel 20) are adjusted by the road wheel actuator 14 and its electric motor 22 based on the received actuating signal, so that the road wheels 20 assume an orientation that corresponds to a target road wheel angle of the steerable road wheels 20 that corresponds to the target road wheel angle. For example, the road wheel actuator 14 can include a control loop with feedback that considers the measured value recorded by the sensor 26.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

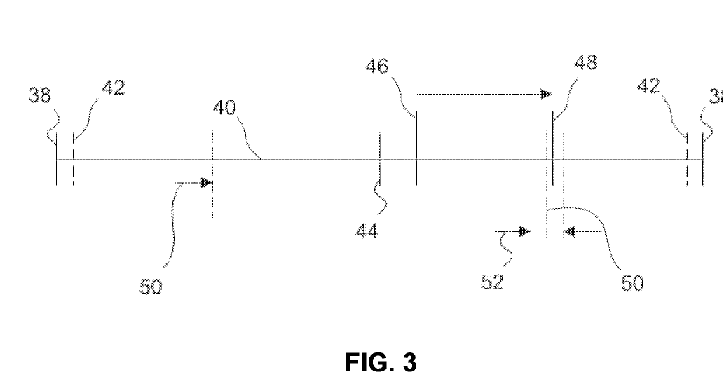

FIG. 3 shows a schematic representation of a road wheel angle range 40 of steerable road wheels 20 in connection with the method of the example. The steerable road wheels 20 are generally movable along the road wheel angle range 40 between the mechanical road wheel angle end stops 38. According to the illustrated example, the control device 16 considers end positions 42 specified by the control system, which prevent the steerable road wheels 20 from reaching the mechanical road wheel angle stop 38. This protects the mechanical road wheel angle end stops 38. A reference position 44 of the road wheel angle range 40 corresponds to a straight line. A current road wheel angle 46 of the steerable road wheels 20 is further illustrated.

A steering input of the driver of vehicle 10 based on a corresponding steering wheel angle is detected by the steering wheel sensor 32. Based on the detected steering wheel angle and considering the vehicle speed of vehicle 10, the target road wheel angle 48 is determined by the control device 16. The target road wheel angle 48 is limited by a road wheel angle limit 50 , which depends on the vehicle speed of the vehicle 10. The road wheel angle limit 50 indicates the target road wheel angle 48 at which the maximum vehicle cross speed change is reached. Further twisting of the steerable road wheels 20 beyond the road wheel angle limit of 50 has no effect due to the vehicle speed and is therefore prevented. Regarding the road wheel angle limit value 50, a tolerance road wheel angle range 52 is considered by the control device 16 to consider an additional parameter range for specific steering situations when measured at the road wheel angle limit value 50.

The tolerance road wheel angle range 52 is measured regarding possible oversteering situations and understeering situations. For example, the road wheel angle of the steerable road wheels 20, which corresponds to a maximum vehicle transverse speed change of 1 G, and additional steering functions of the SBW steering system 12. In some examples, the individual subfactors can lead to different tolerance road wheel angle ranges 52. In some examples, only the largest tolerance road wheel angle range 52 in terms of amount has to be considered, as it includes the other tolerance road wheel angle ranges 52. A maximum value of the target road wheel angle 48 is therefore limited by the road wheel angle limit 50 and the additional tolerance road wheel angle range 52. Based on the target road wheel angle 48, the control device 16 then determines a corresponding control signal, which is output to the electric motor 22 of the road wheel actuator 14.

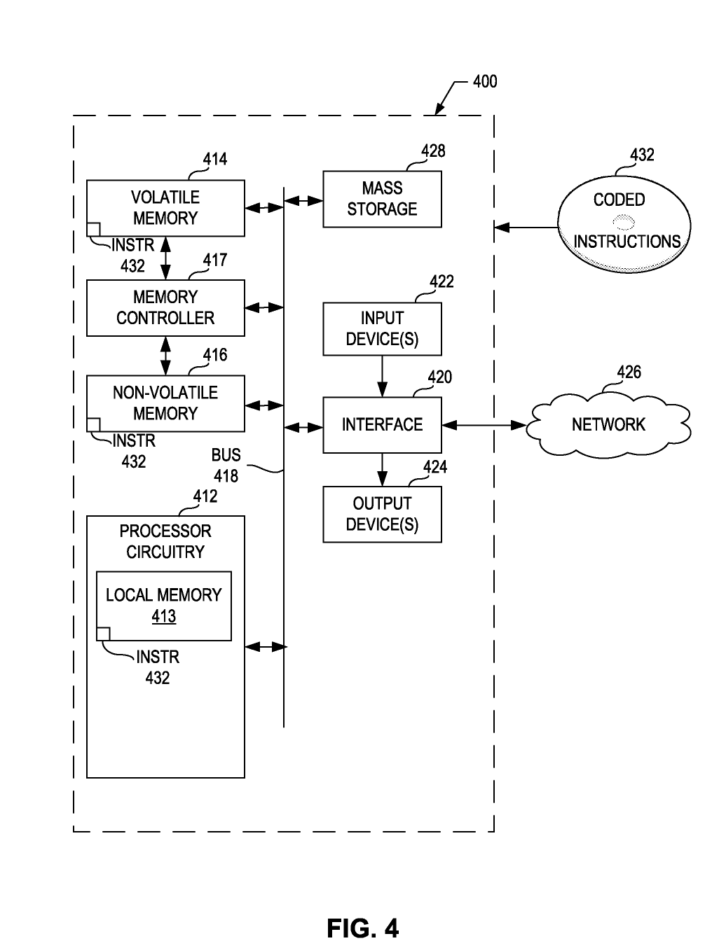

FIG. 4 is a block diagram of an example programmable circuitry platform 400 structured to execute and/or instantiate the example machine-readable instructions and/or the example operations of FIG. [Flowcharts] to implement examples disclosed herein. The programmable circuitry platform 400 can be, for example, a control device, an electronic control unit (ECU), a self-learning machine (e.g., a neural network), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 412 may be implemented by one or more semiconductor based (e.g., silicon based) devices.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a button, a touchscreen, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 432, which may be implemented by the machine-readable instructions of FIG. [Flowcharts], may be stored in the mass storage device 428, in the volatile memory 414, in the non-volatile memory 416, and/or on at least one non-transitory computer readable storage medium such as a CD or DVD which may be removable.

Although the disclosure has been presented and described in relation to one or more examples, after reading and understanding this description and the accompanying drawings, the skilled person will be able to make equivalent changes and modifications.

From the foregoing, it will be appreciated that example systems, apparatus, articles of manufacture, and methods have been disclosed that enable operation of a steer-by-wire steering system for a vehicle. Further examples and combinations thereof include the following:

Example 1 includes a vehicle comprising a road wheel actuator coupled to at least one road wheel of the vehicle, and a control device configured to determine a target road wheel angle of the at least one road wheel based on a speed of the vehicle, and cause the road wheel actuator to steer the at least one road wheel based on the determined target road wheel angle.

Example 2 includes the vehicle of example 1, wherein the control device is configured to determine the target road wheel angle based on the speed of the vehicle and a variable steering ratio of a hand wheel actuator of the vehicle.

Example 3 includes the vehicle of any one or more of examples 1-2, wherein the control device is configured to determine a target rack travel of a steering rack of the vehicle based on the target road wheel angle.

Example 4 includes the vehicle of example 3, wherein the control device is configured to determine the target rack travel of the steering rack based on a travel limit associated with the steering rack.

Example 5 includes the vehicle of any one or more of examples 1-4, wherein the control device is configured to determine the target road wheel angle based on the speed of the vehicle and a road wheel angle limit associated with the vehicle.

Example 6 includes the vehicle of example 5, wherein the control device is configured to determine the road wheel angle limit based on the speed of the vehicle.

Example 7 includes the vehicle of any one or more of examples 5-6, wherein the control device is configured to determine the road wheel angle limit based on a minimum lateral speed associated with the vehicle.

Example 8 includes a non-transitory computer readable storage medium comprising instructions to cause at least one programmable circuitry to determine a target road wheel angle of at least one road wheel of a vehicle based on a speed of the vehicle, and cause a road wheel actuator of the vehicle to steer the at least one road wheel based on the determined target road wheel angle.

Example 9 includes the non-transitory computer readable storage medium of example 8, wherein the at least one programmable circuitry is to determine the target road wheel angle based on the speed of the vehicle and a variable steering ratio of a hand wheel actuator of the vehicle.

Example 10 includes the non-transitory computer readable storage medium of any one or more of examples 8-9, wherein the at least one programmable circuitry is configured to determine a target rack travel of a steering rack of the vehicle based on the target road wheel angle.

Example 11 includes the non-transitory computer readable storage medium of example 10, wherein the at least one programmable circuitry is to determine the target rack travel of the steering rack based on a travel limit associated with the steering rack.

Example 12 includes the non-transitory computer readable storage medium of any one or more of examples 8-11, wherein the at least one programmable circuitry is to determine the target road wheel angle based on the speed of the vehicle and a road wheel angle limit associated with the vehicle.

Example 13 includes the non-transitory computer readable storage medium of example 12, wherein the at least one programmable circuitry is to determine the road wheel angle limit based on the speed of the vehicle.

Example 14 includes the non-transitory computer readable storage medium of any one or more of examples 12-13, wherein the at least one programmable circuitry is to determine the road wheel angle limit based on a minimum lateral speed associated with the vehicle.

Example 15 includes a method comprising determining a target road wheel angle of at least one road wheel of a vehicle based on a speed of the vehicle, and causing a road wheel actuator of the vehicle to steer the at least one road wheel based on the determined target road wheel angle.

Example 16 includes the method of example 15, wherein determining the target road wheel angle is further based on a variable steering ratio of a hand wheel actuator of the vehicle.

Example 17 includes the method of any one or more of examples 15-16, further including determining a target rack travel of a steering rack of the vehicle based on the target road wheel angle.

Example 18 includes the method of example 17, further including determining the target rack travel based on a travel limit associated with the steering rack.

Example 19 includes the method of any one or more of examples 15-18, wherein determining the target road wheel angle is further based on a road wheel angle limit associated with the vehicle.

Example 20 includes the method of example 19, further including determining the road wheel angle limit based on a minimum lateral speed associated with the vehicle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising:
a road wheel actuator coupled to at least one road wheel of the vehicle; and
a control device configured to:
determine a target road wheel angle of the at least one road wheel based on a speed of the vehicle; and
cause the road wheel actuator to steer the at least one road wheel based on the determined target road wheel angle.

2. The vehicle of claim 1, wherein the control device is configured to determine the target road wheel angle based on the speed of the vehicle and a variable steering ratio of a hand wheel actuator of the vehicle.

3. The vehicle of claim 1, wherein the control device is configured to determine a target rack travel of a steering rack of the vehicle based on the target road wheel angle.

4. The vehicle of claim 3, wherein the control device is configured to determine the target rack travel of the steering rack based on a travel limit associated with the steering rack.

5. The vehicle of claim 1, wherein the control device is configured to determine the target road wheel angle based on the speed of the vehicle and a road wheel angle limit associated with the vehicle.

6. The vehicle of claim 5, wherein the control device is configured to determine the road wheel angle limit based on the speed of the vehicle.

7. The vehicle of claim 5, wherein the control device is configured to determine the road wheel angle limit based on a minimum lateral speed associated with the vehicle.

8. A non-transitory computer readable storage medium comprising instructions to cause at least one programmable circuitry to:
determine a target road wheel angle of at least one road wheel of a vehicle based on a speed of the vehicle; and
cause a road wheel actuator of the vehicle to steer the at least one road wheel based on the determined target road wheel angle.

9. The non-transitory computer readable storage medium of claim 8, wherein the at least one programmable circuitry is to determine the target road wheel angle based on the speed of the vehicle and a variable steering ratio of a hand wheel actuator of the vehicle.

10. The non-transitory computer readable storage medium of claim 8, wherein the at least one programmable circuitry is configured to determine a target rack travel of a steering rack of the vehicle based on the target road wheel angle.

11. The non-transitory computer readable storage medium of claim 10, wherein the at least one programmable circuitry is to determine the target rack travel of the steering rack based on a travel limit associated with the steering rack.

12. The non-transitory computer readable storage medium of claim 8, wherein the at least one programmable circuitry is to determine the target road wheel angle based on the speed of the vehicle and a road wheel angle limit associated with the vehicle.

13. The non-transitory computer readable storage medium of claim 12, wherein the at least one programmable circuitry is to determine the road wheel angle limit based on the speed of the vehicle.

14. The non-transitory computer readable storage medium of claim 12, wherein the at least one programmable circuitry is to determine the road wheel angle limit based on a minimum lateral speed associated with the vehicle.

15. A method comprising:
determining a target road wheel angle of at least one road wheel of a vehicle based on a speed of the vehicle; and
causing a road wheel actuator of the vehicle to steer the at least one road wheel based on the determined target road wheel angle.

16. The method of claim 15, wherein determining the target road wheel angle is further based on a variable steering ratio of a hand wheel actuator of the vehicle.

17. The method of claim 15, further including determining a target rack travel of a steering rack of the vehicle based on the target road wheel angle.

18. The method of claim 17, further including determining the target rack travel based on a travel limit associated with the steering rack.

19. The method of claim 15, wherein determining the target road wheel angle is further based on a road wheel angle limit associated with the vehicle.

20. The method of claim 19, further including determining the road wheel angle limit based on a minimum lateral speed associated with the vehicle.
